(19) United States
(12) Patent Application Publication
(10) Pub. No.: US 2025/0141622 A1
(43) Pub. Date: May 1, 2025

(54) Triggered Sounding NDP

(71) Applicant: Huawei Technologies Co., Ltd., Shenzhen (CN)

(72) Inventors: Genadiy Tsodik, Hod Hasharon (IL); Shimon Shilo, Hod Hasharon (IL); Arik Klein, Hod Hasharon (IL); Oded Redlich, Hod Hasharon (IL); Doron Ezri, Hod Hasharon (IL)

(21) Appl. No.: 19/009,591

(22) Filed: Jan. 3, 2025

Related U.S. Application Data
(63) Continuation of application No. PCT/EP2022/068656, filed on Jul. 6, 2022.

(51) Int. Cl. H04L 5/00; H04W 84/12

(52) U.S. Cl. CPC H04L 5/005; H04W 84/12

(57) ABSTRACT

A method of uplink sounding signal triggering, performed by an access point (AP), comprises the steps of transmitting, by the AP, a triggering signal to one or more stations (STAs), triggering transmission of a respective sounding signal from at least one STA of the one or more STAs in response to the triggering signal; receiving, by the AP, the respective sounding signal from the at least one STA; and determining, by the AP, a precoder to be used by the at least one STA based on the respective sounding signal, and transmitting corresponding precoder information to the at least one STA for data transmission, wherein the triggering signal comprises a null data packet announcement (NDPA) signal or a null data packet request (NDPR) signal and the sounding signal comprises a triggered sounding null data packet (NDP) signal.

### CROSS-REFERENCE TO RELATED APPLICATIONS

This is a continuation of International Patent Application No. PCT/EP2022/068656 filed on Jul. 6, 2022, the disclosure of which is hereby incorporated by reference in its entirety.

### TECHNICAL FIELD

The present disclosure relates to methods of uplink sounding signal triggering.

### BACKGROUND

Beamforming (BF) is widely used in Wi-Fi communications as a successful technique to improve performance in multiple-input multiple-output (MIMO) scenarios. Beamforming is a process by which the sender of a transmission can send a signal in a preferred direction toward a receiver to increase the signal-to-noise ratio (SNR) and the speed of the transmission. Generally, it can be grouped into two main types. Explicit beamforming is based on exchanging information between the transmitter and receiver about the characteristics of the radio channel to extract improved performance from the radio channel based on channel quality measurements, while in implicit beamforming the measurement frame is sent by the beamformee and not the beamformer. The beamformer detects the frame and uses it for channel estimation while assuming the reciprocity between downlink and uplink channels. The baseband digital signal is changed according to channel. Beamforming has been supported since Institute of Electrical and Electronics Engineers (IEEE) 802.11n.

In 802.11n, multiple sounding mechanisms are defined to support BF operation (e.g. implicit sounding where uplink signals are used, assuming reciprocity, to determine the beamforming weights or precoders, and explicit sounding where dedicated signals are being transmitted so that the intended receiver—beamformee—computes the precoding weights).

Beamforming in 802.11n required two devices to implement mutually agreeable beamforming functions. 802.11ac specifies up to eight spatial streams, compared to 802.11n's four spatial streams, at an access point (AP). The multiple spatial streams can be used to transmit to multiple clients at the same time.

In 802.11ac and 802.11ax, explicit sounding is the only mechanism defined to support BF operation.

Beamforming is supported for both downlink (DL) and uplink (UL).

DL beamforming is fully managed by the AP while the precoder can be adjusted according to currently scheduled transmission. Different transmission schemes may require different precoders to achieve better performance. The AP collects the feedback information from different stations and may compute the relevant precoder optimized for specific packet.

In UL, the same procedure is applied while the station (STA) acts as a beamformer and thus triggers the procedure and collects the precoder feedback from the beamformee, here the AP. This means that STA holds the precoder information and decides when and which precoder to apply.

According to the existing protocol in 802.11ax, UL BF is supported by the STA transmitting a null data packet (NDP) preceded by an NDP Announcement (NDPA) frame, followed by the AP's response with a Beamforming Report (BFR).

A new feature in 802.11ax (compared with earlier 802.11 standards) is the introduction of the trigger frame (TF), a frame that instructs the intended receiver—typically an STA—to transmit in response to receiving the TF.

However, a suitable format for using triggered transmissions for UL BF is missing.

### SUMMARY

In view of the above, it is an objective underlying the present disclosure to at least partially overcome the above indicated disadvantages and to achieve that the transmit (Tx) parameters of a trigger-based (TB) physical protocol data unit (PPDU) are set by the AP for a triggered sounding NDP in UL.

The foregoing and other objectives are achieved by the subject matter of the independent claims. Further implementation forms are apparent from the dependent claims, the description and the figures.

According to a first aspect a method of uplink sounding signal triggering, performed by an AP is provided, comprising the steps of transmitting, by the AP, a triggering signal to one or more stations STAs, triggering transmission of a respective sounding signal from at least one STA of the one or more STAs in response to the triggering signal; receiving, by the AP, the respective sounding signal from the at least one STA; and determining, by the AP, a precoder to be used by the at least one STA based on the respective sounding signal, and transmitting corresponding precoder information to the at least one STA for data transmission; wherein the triggering signal comprises an NDPA signal or a null data packet request (NDPR) signal and the sounding signal comprises a triggered sounding NDP signal; wherein the triggered sounding NDP signal is based on a TB PPDU frame without a payload or based on an Extremely High Throughput (EHT) multi-user (MU) PPDU frame without a payload; and wherein a universal signal (U-SIG) section of the TB PPDU frame or the EHT MU PPDU frame of the triggered sounding NDP signal comprises parameters indicating a triggered NDP transmission. Here, an optional EHT-SIG section of the EHT MU PPDU frame of the triggered sounding NDP signal can be omitted.

The present disclosure provides a U-SIG section of the TB PPDU or a U-SIG section of the EHT MU PPDU frame of the triggered sounding NDP signal that comprises parameters indicating a triggered NDP transmission. Accordingly, the AP can be informed that the transmission is a triggered NDP transmission. The “triggered sounding NDP” signal is a new format of signal, different from other sounding NDP signals. With the new format (variants of existing PPDU types) of triggered sounding NDP, no payload is involved and the STA identification might be done by using physical properties of the transmitted signals, such as power of the estimated channel of each triggered source, for example.

According to an implementation, a PPDU type, TB PPDU or EHT MU PPDU, and/or a PPDU variant for the triggered sounding NDP signal is indicated in a PPDU Type and Compressed Mode field in the U-SIG section. Here option 1 is a new variant of TB PPDU type with different U-SIG design and option 2 is a new variant of EHT MU PPDU with different U-SIG design and optional EHT-SIG field (redundant for triggered transmission). Both options allow to achieve the properties to ensure all the STAs transmit the same preamble contents, to recognize that this is a solicited NDP transmission (avoid hidden nodes or interferers), and to allow AP to reuse detector of TB PPDU.

According to an implementation, the PPDU Type and Compressed Mode field may be set to 2 or 3.

According to an implementation, the PPDU Type and Compressed Mode field may be set to 0 and B2 of U-Sig-2 is set to 1 to indicate triggered sounding NDP.

According to an implementation, the PPDU Type and Compressed Mode field may be set to 0 and a combination of 11 disregard bits of U-SIG may be used to indicate triggered sounding NDP.

According to an implementation, the U-SIG section of the triggered sounding NDP signal includes an UL/DL field that may be set to 1.

According to an implementation, the U-SIG section of the triggered sounding NDP signal may include a Spatial Reuse field that is Reserved or set to Disallow such that a spatial reuse is not allowed when the triggered NDP transmission is indicated.

According to an implementation, a bandwidth (BW) indicated in the U-SIG section of the triggered sounding NDP may be the same as the BW indicated by the NDPA or the NDPR triggering signal.

According to an implementation, a Puncturing Channel Information field of the U-SIG section may be reserved.

According to an implementation, a number of EHT-SIG symbols indication field of the U-SIG section may be reserved.

According to the U-SIG design for option 1 with a Triggered Sounding NDP as EHT TB PPDU variant, one or more changes to the U-SIG design may be introduced as defined in the implementations above: UL/DL shall be set to ‘1’, and/or BW shall be same as indicated by NDPR, and/or spatial reuse is not allowed if a Triggered NDP is indicated, thus Spatial Reuse fields may be set to “Disallow” or may be reserved.

According to the U-SIG design for option 2 with the Triggered Sounding NDP as EHT MU PPDU variant, one or more changes to the U-SIG design may be introduced as defined in the implementations above: Puncturing Channel Information is not required for a Triggered NDP—field is reserved, and/or # of EHT-SIG symbols is always 1—field is reserved, and/or UL/DL is set to ‘1’, and/or BW is the same as indicated by NDPR.

According to a second aspect a method of uplink sounding signal triggering, performed by an STA, is provided, comprising the steps of receiving, by the STA, a triggering signal from an AP; transmitting a sounding signal from the STA to the AP in response to the triggering signal; and receiving, by the STA from the AP, precoder information corresponding to a precoder determined by the AP based on the sounding signal and to be used by the STA for data transmission; wherein the triggering signal comprises an NDPA signal or an NDPR signal and the sounding signal comprises a triggered sounding NDP signal; wherein the triggered sounding NDP signal is based on a TB PPDU frame without a payload or based on an EHT MU PPDU frame without a payload; and wherein a U-SIG section of the TB PPDU or the EHT MU PPDU frame of the triggered sounding NDP signal comprises parameters indicating a triggered NDP transmission.

The explanations and advantages provided above apply here vis-a-vis. In order to avoid repetition, these are omitted here and in the following.

According to an implementation, a PPDU type, TB PPDU or EHT MU PPDU, and/or a PPDU variant for the triggered sounding NDP signal may be indicated in a PPDU Type and Compressed Mode field in the U-SIG section.

According to an implementation, the PPDU Type and Compressed Mode field may be set to 2 or 3.

According to an implementation, the PPDU Type and Compressed Mode field is set to 0 and B2 of U-Sig-2 may be set to 1 to indicate triggered sounding NDP.

According to an implementation, the PPDU Type and Compressed Mode field may be set to 0 and a combination of 11 disregard bits of U-SIG may be used to indicate triggered sounding NDP.

According to an implementation, the U-SIG section of the triggered sounding NDP signal may include an UL/DL field that is set to 1.

According to an implementation, the U-SIG section of the triggered sounding NDP signal may include a Spatial Reuse field that is Reserved or set to Disallow such that a spatial reuse is not allowed when the triggered NDP transmission is indicated.

According to an implementation, a BW indicated in the U-SIG section of the triggered sounding NDP may be the same as the BW indicated by the NDPA or the NDPR triggering signal.

According to an implementation, a Puncturing Channel Information field of the U-SIG section may be reserved.

According to an implementation, a number of EHT-SIG symbols indication field of the U-SIG section may be reserved.

According to a third aspect, a method of uplink sounding signal triggering, performed by an AP, is provided, comprising the steps of transmitting, by the AP, a triggering signal to one or more STAs, triggering transmission of a respective sounding signal from at least one STA of the one or more STAs in response to the triggering signal; receiving, by the AP, the respective sounding signal from the at least one STA; and determining, by the AP, a precoder to be used by the at least one STA based on the respective sounding signal, and transmitting corresponding precoder information to the at least one STA for data transmission; wherein the triggering signal comprises an NDPA signal or an NDPR signal and the sounding signal comprises a triggered sounding NDP signal; wherein the triggered sounding NDP signal is based on an EHT TB PPDU frame including a data portion; and wherein the EHT TB PPDU frame transmits a number K of spatial streams (SS) in an EHT Long Training Field (LTF) portion and a number N of SS in the data portion, the EHT TB PPDU frame being configured to allow K being independent from N.

Accordingly, the present disclosure provides for an EHT TB PPDU frame being configured to allow the number K of SS in the EHT LTF portion being unrelated to the number N of SS in the data portion. In other words, the number N does not define the number K by a fixed relation.

Such a modification of TB PPDU transmission rules supports the case when number of Tx antennas is larger than the number of supported SSs.

According to an implementation, the number K of SS in an EHT LTF portion may depend on a number M of Tx antennas.

According to an implementation, the EHT LTF portion may comprise EHT LTF orthogonal frequency-division multiplexing (OFDM) symbols, the number K of EHT LTF OFDM symbols being according to a number K of Tx antennas as indicated by the at least one STA in a capabilities report.

According to an implementation, the AP may indicate by the NDPA signal which subset of transmit antennas shall be used for transmission by the at least one STA.

According to an implementation, the triggered sounding NDP may be received by the AP from a subset of Tx antennas of the at least one STA.

According to an implementation, a PPDU type, EHT MU PPDU, and/or a PPDU variant for the triggered sounding NDP signal may be indicated in a PPDU Type and Compressed Mode field in the U-SIG section.

According to an implementation, the PPDU Type and Compressed Mode field may be set to 2 or 3.

According to an implementation, the PPDU Type and Compressed Mode field may be set to 0 and B2 of U-Sig-2 may be set to 1 to indicate triggered sounding NDP.

According to an implementation, the PPDU Type and Compressed Mode field may be set to 0 and a combination of 11 disregard bits of U-SIG may be used to indicate triggered sounding NDP.

Therefore, in this aspect and according to an option 1, a new variant of TB PPDU type is provided with a number of SS for EHT-LTF (K) and a number of SS in the Data portion (N), which numbers are independent from each other. In an exemplary case, data portion will be transmitted with single SS (N=1) copied for all the antennas while K will be according to number of Tx antennas as indicated by the STA in capabilities report.

According to an option 2, a new variant of TB PPDU type with selected Tx antennas as indicated by NDPR. The AP may indicate which subset of Tx antennas should be used for transmission and STA will transmit using indicated subset (in this case K may be less or equal number of supported SSs for data transmission).

According to the fourth aspect, a method of uplink sounding signal triggering, performed by an STA, is provided, comprising the steps of receiving, by the STA, a triggering signal from an AP; transmitting a sounding signal from the STA to the AP in response to the triggering signal; and receiving, by the STA from the AP, precoder information corresponding to a precoder determined by the AP based on the sounding signal and to be used by the STA for data transmission; wherein the triggering signal comprises an NDPA signal or an NDPR signal and the sounding signal comprises a triggered sounding NDP signal; wherein the triggered sounding NDP signal is based on an EHT TB PPDU frame including a data portion; and wherein the EHT TB PPDU frame transmits a number K of SS in an EHT LTF portion and a number N of SS in the data portion, the EHT TB PPDU frame being configured to allow K being independent from N.

The explanations and advantages described above apply vis-a-vis. In order to avoid repetition, these are omitted here and in the following.

According to an implementation, the number K of SS in an EHT LTF portion depends on a number M of Tx antennas.

According to an implementation, the EHT LTF portion may comprise EHT LTF OFDM symbols, the number K of EHT LTF OFDM symbols being according to a number K of Tx antennas as indicated by the at least one STA in a capabilities report.

According to an implementation, the AP may indicate by the NDPA signal which subset of Tx antennas shall be used for transmission by the at least one STA.

According to an implementation, the triggered sounding NDP may be received by the AP from a subset of transmit antennas of the at least one STA.

According to an implementation, a PPDU type, EHT MU PPDU, and/or a PPDU variant for the triggered sounding NDP signal may be indicated in a PPDU Type and Compressed Mode field in the U-SIG section.

According to an implementation, the PPDU Type and Compressed Mode field may be set to 2 or 3.

According to an implementation, the PPDU Type and Compressed Mode field may be set to 0 and B2 of U-Sig-2 may be set to 1 to indicate triggered sounding NDP.

According to an implementation, the PPDU Type and Compressed Mode field may be set to 0 and a combination of 11 disregard bits of U-SIG may be used to indicate triggered sounding NDP.

According to a fifth aspect, an AP is provided, comprising processing circuitry configured to perform the method of uplink sounding signal triggering, performed by an AP described above, or any implementation thereof.

According to a sixth aspect, an STA is provided, comprising processing circuitry configured to perform the method of uplink sounding signal triggering, performed by an STA described above, or any implementation thereof.

According to a seventh aspect, a computer program is provided, comprising instructions which, when the program is executed by a computer, cause the computer to carry out any one of the methods of uplink sounding signal triggering described above.

According to a sixth aspect, a computer-readable medium is provided, comprising instructions which, when executed by a computer, cause the computer to carry out any one of the methods of uplink sounding signal triggering described above.

### BRIEF DESCRIPTION OF THE DRAWINGS

In the following, embodiments of the present disclosure are described in more detail with reference to the attached figures and drawings, in which:

FIG. 1 illustrates an UL beamforming scheme.

FIG. 2 illustrates the EHT NDP format.

FIGS. 3A and 3B illustrate the indication of PPDU Type and Variants.

FIG. 4 illustrates TB Ranging NDP in 802.11az.

FIG. 5 illustrates an EHT TB PPDU variant for Triggered Sounding NDP.

FIG. 6 illustrates an EHT MU PPDU variant for Triggered Sounding NDP.

FIG. 7 illustrates the method according to the first aspect, performed by an AP.

FIG. 8 illustrates a U-SIG Design for new TB PPDU Variant.

FIG. 9 illustrates a U-SIG Design for new EHT MU PPDU Variant.

FIG. 10 illustrates the method according to the second aspect, performed by an STA.

FIG. 11 illustrates the method according to the third aspect, performed by an AP.

FIG. 12 illustrates a U-SIG Design for new EHT TB PPDU Variant.

FIG. 13 illustrates the method according to the fourth aspect, performed by an STA.

FIG. 14 illustrates a Tx Antennas physical layer (PHY) Element.

FIG. 15 illustrates an AP according to the fifth aspect.

FIG. 16 illustrates an STA according to the sixth aspect.

FIG. 17 illustrates simulation results.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Further implementation details and advantages will be described in the following.

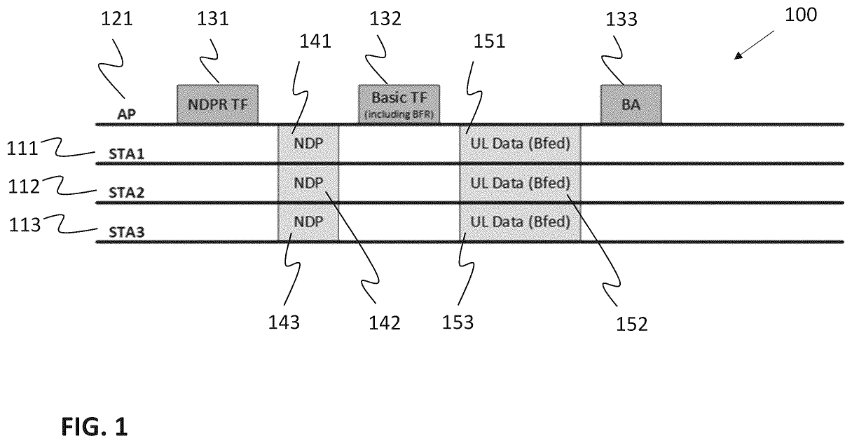

FIG. 1 illustrates the general concept 100 to initialize data upload from one or more STAs 111, 112, 113 to an AP 121 that start with an NDPR TF 131 transmitted by the AP 121 to the STAs 111, 112, 113 and a respective NDP 141, 142, 143 transmitted in response by the STA or STAs 111, 112, 113 to the AP 121. An NDP 141, 142, 143 is a packet which contains a preamble, including LTFs, and can be used for estimating the physical channel(s) between the AP 121 and the STA(s) 111, 112, 113. The NDP 141, 142, 143 may be transmitted simultaneously by several STAs 111, 112, 113. These NDP signals 141, 142, 143 are used by the AP 121 to determine precoding information in order to perform beamforming. Thereafter, a Basic TF 132 is transmitted to the STAs 111, 112, 113 including a BFR. This is a frame which carries the beamforming/precoding information, such as precoding vector or matrix, SNR corresponding to each precoder, etc. Upon receipt of the Basic TF 132, the STA(s) 111, 112, 113 start to transmit beamformed data 151, 152, 153 in UL to the AP 121. The AP 121 acknowledges receipt of a data block using a block data acknowledgement (BA) frame 133.

In some approaches, an NDP may be used for sounding procedure as a frame that is transmitted immediately after an NDPA frame and by the same source that transmitted the NDPA frame. The structure of the EHT NDP is of EHT MU PPDU type, which is mostly used in transmissions that are not solicited by the recipient (i.e., non-triggered transmission). A PPDU which is transmitted in response to receiving a TF is called a TB PPDU. An STA 111, 112, 113 which is triggered to transmit in the UL is called a Triggered STA. In a TB PPDU transmission of all the Tx parameters of a TB PPDU are set by the AP 121 and the AP 121 identifies each transmitter 111, 112, 113 via the decoded payload (e.g. medium access control (MAC) header).

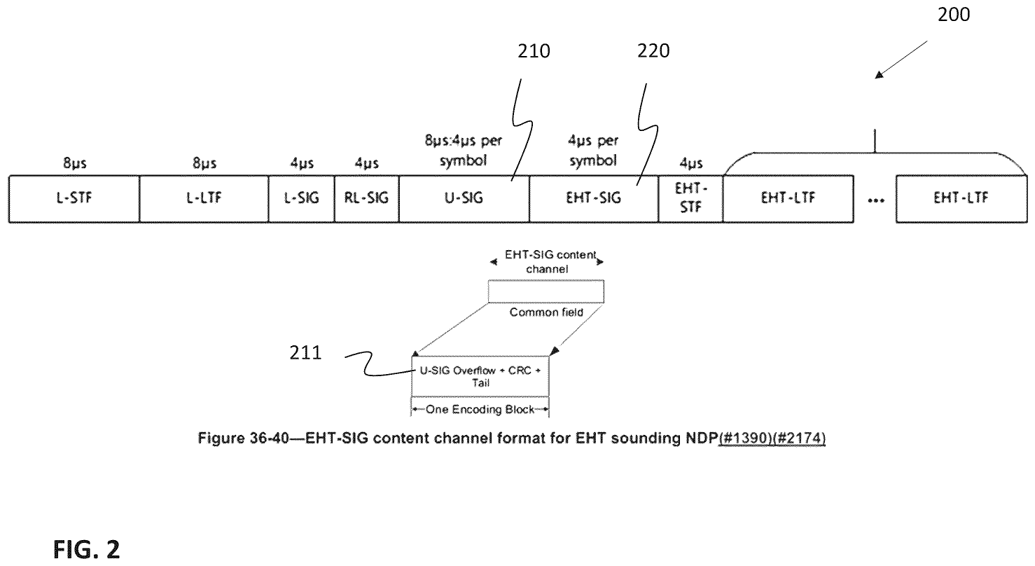

As shown in FIG. 2, the EHT NDP preamble 200 comprises both U-SIG 210 and EHT signal (EHT-SIG) 220, wherein EHT-SIG 220 has only U-SIG overflow bits 211 (bits that belong to U-SIG 210 but are located at EHT-SIG 220 due to limited U-SIG size).

Further, in 802.11be (EHT) there are two main PPDU types: EHT MU PPDU type and TB PPDU type. All the PPDUs are transmitted using one of those types. In addition, EHT defines several variants of those types. Variants reuse the same structure of the PPDU type but may differ in meaning of specific fields or number of specific parameters.

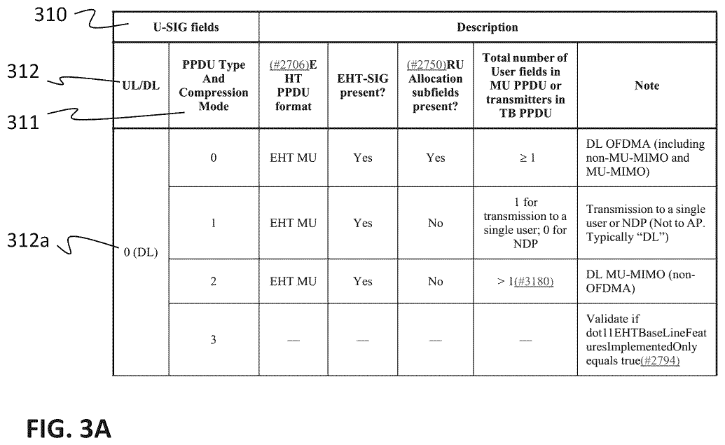

FIGS. 3A, 3B illustrate that an EHT PPDU type and variant is indicated in U-SIG of the SIG field information 310 by a field named PPDU Type and Compressed Mode 311 (two bits) and a field named DL/UL (one bit) 312. Download is indicated by “0” denoted by 312a and upload by “1” denoted by 312b. For upload, the PPDU Type and Compressed Mode field values “0” denoted by 311a and “1” denoted by 311b indicate PPDU Type EHT TB and EHT MU, respectively, while the values “2” and “3” denoted by 311c are presently not used.

As mentioned above with reference to FIG. 1, in UL BF the NDP 141, 142, 143 will be transmitted by the STAs 111, 112, 113 that are triggered by AP 121. But there is a gap between current TB PPDU properties and NDP format as explained in the following.

Today, TB PPDU has two main properties, namely (i) all the Tx parameters are set by AP 121—this ensures alignment between all the STAs 111, 112, 113 and thus the preamble of TB PPDU can be detected by third receiver, and as the AP defined the parameters it may skip detection of the preamble; and (ii) the AP 121 identifies each transmitter 111, 112, 113 via the decoded payload (e.g. MAC header)—successful reception of the data payload transmitted by the STA 111, 112, 113 allows AP 121 to identify the transmitter with extremely low error probability.

However, the current format of NDP does not allow to achieve the same properties in the UL BF case where multiuser NDP transmission is triggered by the AP 121.

Thus, it is desirable to have a new NDP design or alternative solution that may allow to achieve the same properties in UL BF triggered sounding NDP.

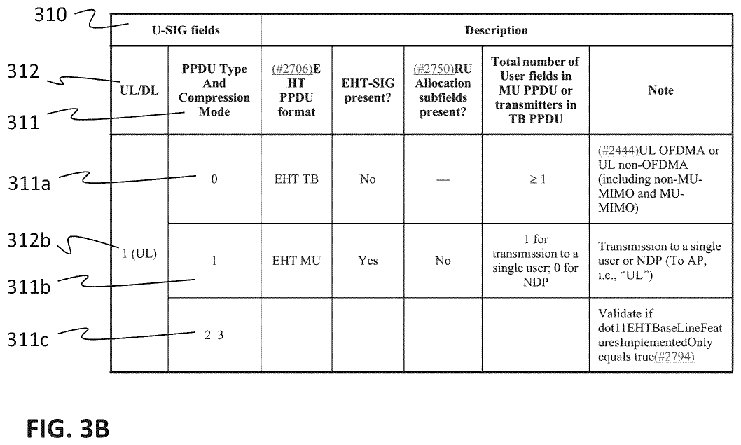

In the 802.11az standard, a TB PPDU is used in and an AP 121 triggers multiple STAs 111, 112, 113 to transmit an NDP frame and the STAs 111, 112, 113 transmit a TB PPDU with no payload instead. FIG. 4 shows an NDP frame 400 in the form of a TB PPDU 400 without data field.

Although it allows alignment between multiple STAs 111, 112, 113, the TB PPDU 400 with no payload it has the disadvantages that there is no robust STA 111, 112, 113 identification (which is less important for 802.11az purpose) such that the TB PPDU of 802.11az is not robust enough for beamforming.

Thus, it can be seen that the format adopted by 802.11az doesn't provide the required properties.

A simple approach that might be considered in this regard is to use a regular TB PPDU with some short payload instead of NDP. This might solve the problem of identification and also alignment between the STAs 111, 112, 113.

However, this method also has drawbacks and related problems involved. Some STA 111, 112, 113 may have more transmit antennas than number of supported SSs in UL TB transmission. TB PPDU format forces number of SSs in EHT-LTF portion to be equal to number of SSs in data portion. Thus, such an STA 111, 112, 113 cannot transmit from all the Tx antennas. This results in partial channel matrix estimation at AP and thus non-accurate beamforming precoder.

As can be seen, there are several formats that provide partial solutions of the problem, however, it is proposed in this disclosure to modify/change a design of NDP and TB PPDU in order to fully achieve the target properties of alignment and identification.

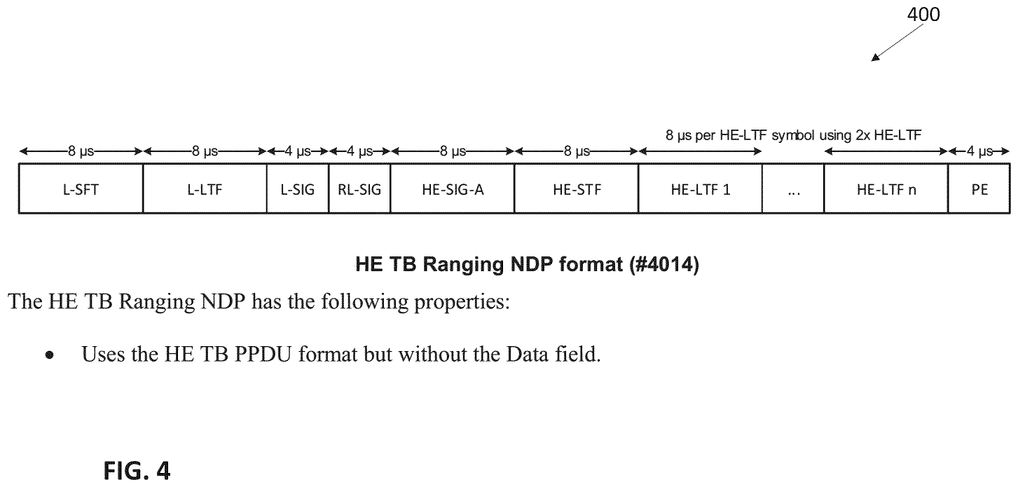

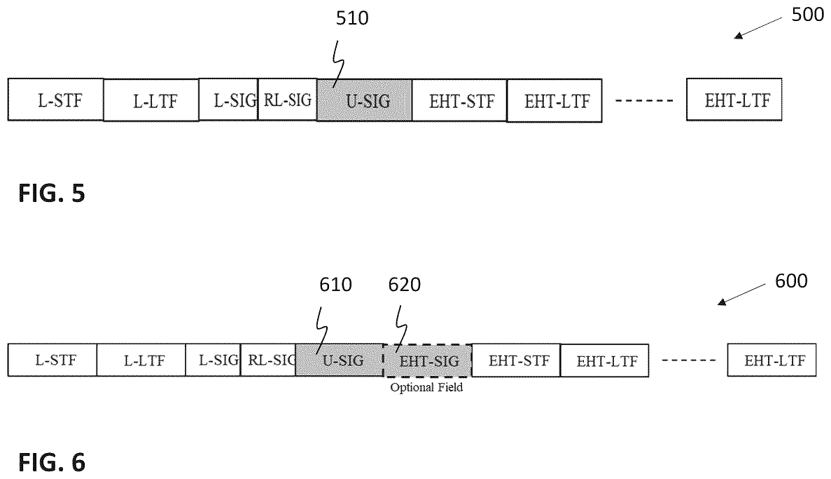

FIG. 5 shows the regular preamble 500 of the TB PPDU having the U-SIG field 510. Further, FIG. 6 shows the regular preamble 600 of the TB PPDU having the U-SIG field 610 and an optional EHT-SIG field 620, which is redundant for triggered transmission.

According to the present disclosure, the regular preamble of TB PPDU is reused, since part of the fields are not relevant and can be redesigned for UL BF.

The main idea of this disclosure are new formats for TB PPDU and Triggered NDP that can support the requirements of UL BF protocol.

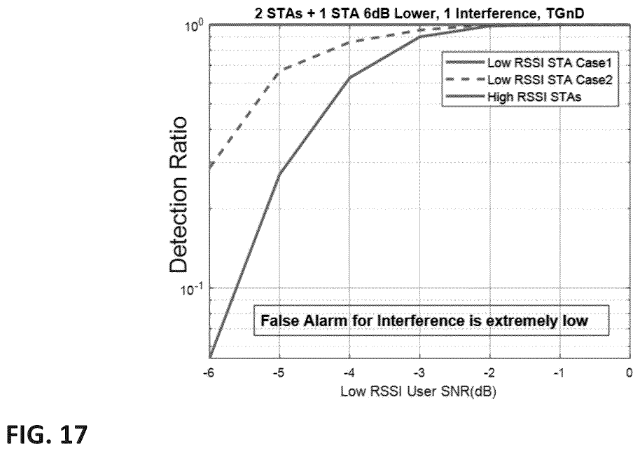

Two general possibilities are disclosed. The method according to first and second aspect provide new formats (variants of existing PPDU types) for triggered sounding NDP (in this method there is no payload and STA identification might be done by power of the estimated channel of each triggered source (SS), see also FIG. 17 and the related description below). The method according the third and fourth aspect provide modification of TB PPDU transmission rules to support the case when number of Tx antennas is larger than number of supported SSs.

Both methods provide a solution for the above-identified problem.

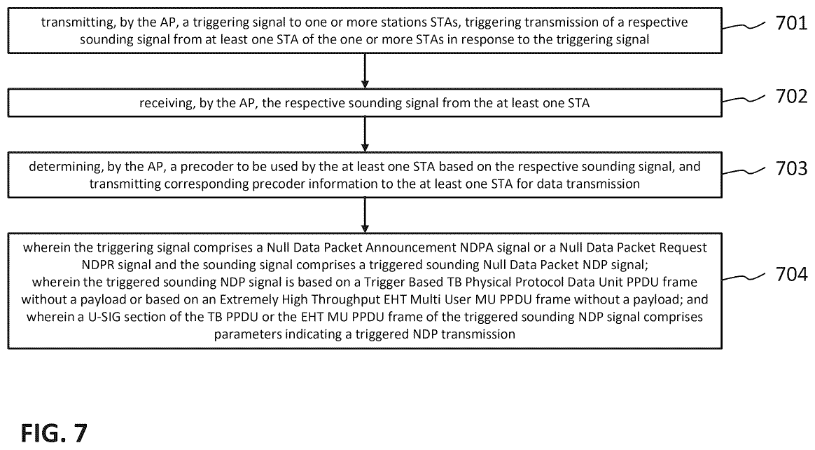

FIG. 7 (with further reference to FIGS. 1, 8, and 9) illustrates a general formulation of the method of uplink sounding signal triggering according to the first aspect, performed by an access point AP 121, according to the first aspect of the present disclosure, comprising the following steps.
701: transmitting, by the AP 121, a triggering signal to one or more STAs 111, 112, 113, triggering transmission of a respective sounding signal from at least one STA 111, 112, 113 of the one or more STAs 111, 112, 113 in response to the triggering signal;
702: receiving, by the AP 121, the respective sounding signal from the at least one STA 111, 112, 113; and
703: determining, by the AP 121, a precoder to be used by the at least one STA 111, 112, 113 based on the respective sounding signal, and transmitting corresponding precoder information to the at least one STA 111, 112, 113 for data transmission;
704: wherein the triggering signal comprises an NDPA signal or an NDPR signal and the sounding signal comprises a triggered sounding NDP signal; wherein the triggered sounding NDP signal is based on a TB PPDU frame 800 without a payload or based on an EHT MU PPDU frame 900 without a payload; and wherein a U-SIG section 810, 910 of the TB PPDU or the EHT MU PPDU frame of the triggered sounding NDP signal comprises parameters indicating a triggered NDP transmission.

The U-SIG section 310, 311a, 510, 810 of the TB PPDU frame 500 or the U-SIG section 310, 311b, 610, 620, 910 of the EHT MU PPDU frame 600 of the triggered sounding NDP signal comprises parameters indicating a triggered NDP transmission (see FIGS. 3, 5, 6, 8, and 9). Thus, the AP 121 can be informed that the transmission is a triggered NDP transmission. The “triggered sounding NDP” signal is a new format of signal, different from other sounding NDP signals. With the new format (variants of existing PPDU types) of triggered sounding NDP, no payload is involved and the STA identification might be done by using physical properties of the transmitted signals, such as power of the estimated channel of each triggered source, for example (see FIG. 17).

Advantages are that it is ensured that all the STAs 111, 112, 113 transmit the same preamble contents, it is recognized that this is a solicited NDP transmission (avoid hidden nodes or interferers), and allows the AP 121 to reuse the detector of TB PPDU.

The general method includes two options, one provides a new variant of TB PPDU type 500 with different U-SIG design 510 (based on FIG. 5, for example) and another option provides a new variant of EHT MU PPDU 600 with different U-SIG design 610 and optional EHT-SIG field 620 (based on FIG. 6, for example).

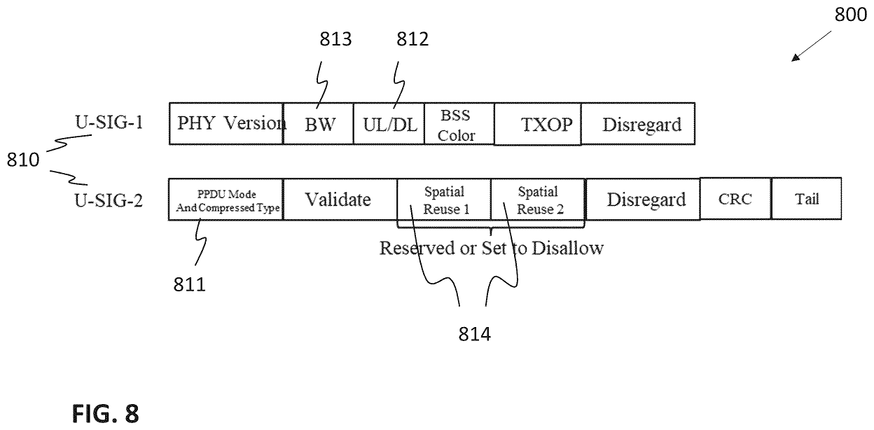

A first embodiment is shown in FIG. 8, related to a Triggered Sounding NDP 800 as an EHT TB PPDU variant. Several changes can be made to U-SIG design 810, such as UL/DL 812 shall be set to ‘1’ and BW 813 shall be same as indicated by NDPR. Spatial reuse is not allowed if a Triggered NDP is indicated, thus Spatial Reuse fields 814 may be set to “Disallow” or may be reserved. The field 811 indicates the PPDU Mode and compression type.

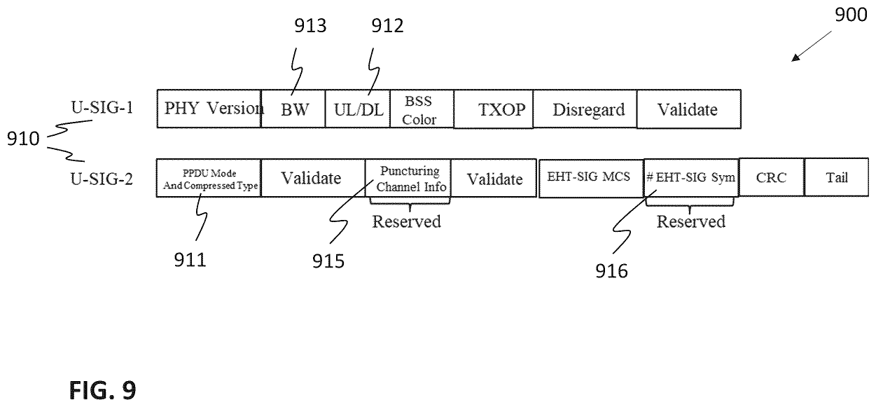

A second embodiment is shown in FIG. 9, related to a Triggered Sounding NDP 900 as EHT MU PPDU variant. The field 911 indicates the PPDU Mode and compression type. Several changes can be made to U-SIG design 910, such as Puncturing Channel Information 915 is not required for a Triggered NDP such that the corresponding field is reserved, the number of EHT-SIG symbols is always 1 and the corresponding field 916 is reserved, UL/DL 912 should be set to ‘1’ and BW 913 should be same as indicated by NDPR.

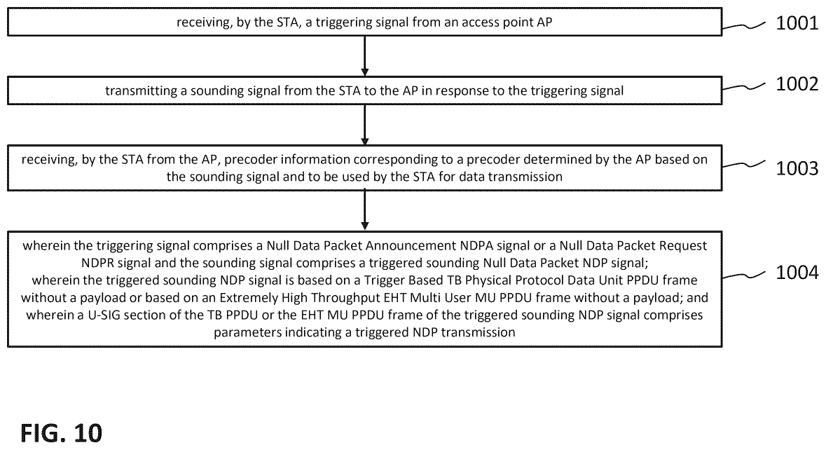

FIG. 10 (with further reference to FIG. 1) illustrates a general method of uplink sounding signal triggering, performed by an STA 111, 112, 113, according to the second aspect, comprising the following steps.
1001: receiving, by the STA 111, 112, 113, a triggering signal from an AP 121;
1002: transmitting a sounding signal from the STA 111, 112, 113 to the AP 121 in response to the triggering signal; and
1003: receiving, by the STA 111, 112, 113 from the AP 121, precoder information corresponding to a precoder determined by the AP based on the sounding signal and to be used by the STA 111, 112, 113 for data transmission;
1004: wherein the triggering signal comprises an NDPA signal or an NDPR signal and the sounding signal comprises a triggered sounding NDP signal; wherein the triggered sounding NDP signal is based on a TB PPDU frame 800 without a payload or based on an EHT MU PPDU frame 900 without a payload; and wherein a U-SIG section 810, 910 of the TB PPDU or the EHT MU PPDU frame of the triggered sounding NDP signal comprises parameters indicating a triggered NDP transmission.

This corresponds to the general method according to the first aspect having corresponding embodiments (FIGS. 8 and 9).

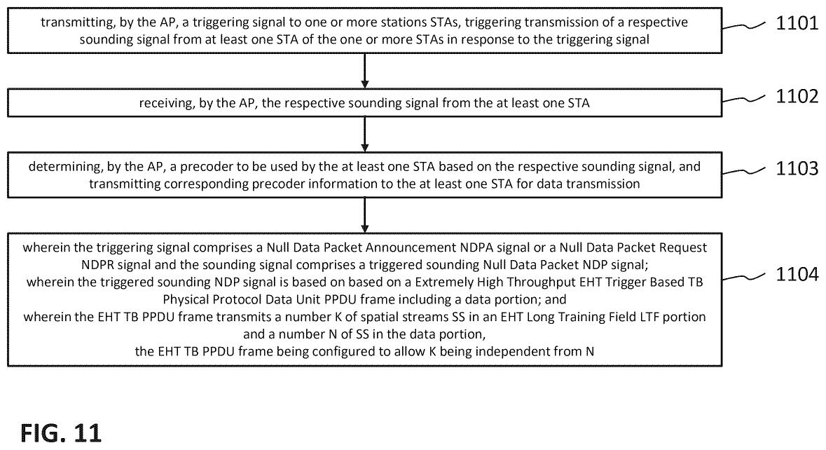

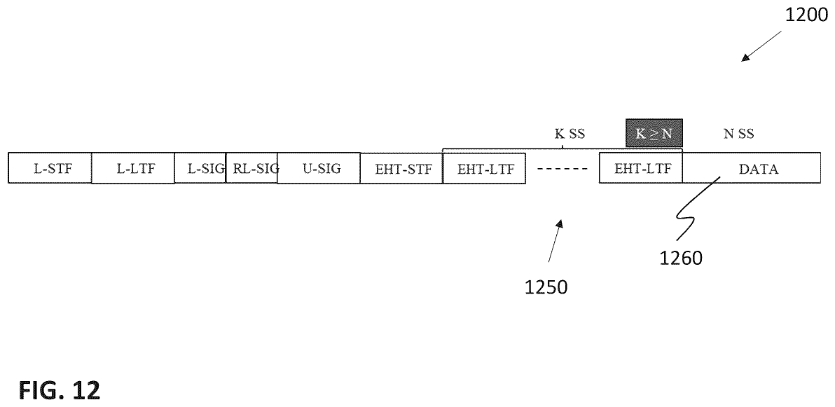

FIG. 11 illustrates (with further reference to FIGS. 1 and 12) a general method of uplink sounding signal triggering, performed by an AP 121, according to the third aspect, comprising the steps of:
1101: transmitting, by the AP 121, a triggering signal to one or more STAs, triggering transmission of a respective sounding signal from at least one STA of the one or more STAs 111, 112, 113 in response to the triggering signal;
1102: receiving, by the AP 121, the respective sounding signal from the at least one STA 111, 112, 113; and
1103: determining, by the AP 121, a precoder to be used by the at least one STA 111, 112, 113 based on the respective sounding signal, and transmitting corresponding precoder information to the at least one STA 111, 112, 113 for data transmission;
1104: wherein the triggering signal comprises an NDPA signal or an NDPR signal and the sounding signal comprises a triggered sounding NDP signal; wherein the triggered sounding NDP signal is based on based on an EHT TB PPDU frame including a data portion; and wherein the EHT TB PPDU frame transmits a number K of SS 1250 in an EHT LTF portion and a number N of SS 1260 in the data portion, the EHT TB PPDU frame being configured to allow K being independent from N.

This provides a new variant for TB PPDU with payload.

As explained above, the problem with TB PPDU (which includes payload) is that presently it is not possible to transmit different number of SSs in EHT-LTF portion and data portion. Here, it is proposed to reuse a TB PPDU main format.

As illustrated in FIG. 12, a first option relates to a new variant of TB PPDU type 1200 with different number of SS for EHT-LTF (number K of SS, reference number 1250) and data portion (number N of SS, reference number 1260). The numbers K and N can be selected independently. In an example, data portion may be transmitted with single SS (N=1) copied for all the antennas while K will be according to number of Tx antennas as indicated by the STA in capabilities report. A second option relates to a new variant of TB PPDU type with selected Tx antennas as indicated by NDPR. The AP may indicate which subset of Tx antennas should be used for transmission and STA will transmit using indicated subset (in this case K may be less or equal number of supported SSs for data transmission).

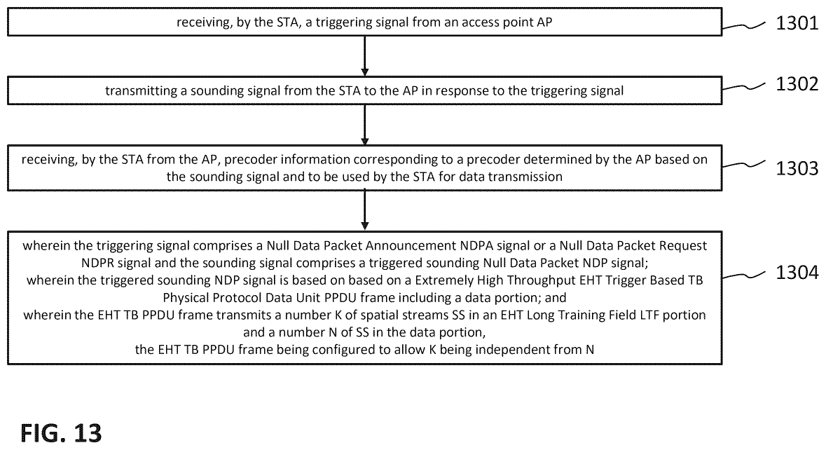

FIG. 13 illustrates (with further reference to FIGS. 1 and 12) a general method of uplink sounding signal triggering, performed by an STA, according to the fourth aspect, comprising the following steps.
1301: receiving, by the station STA 111, 112, 113, a triggering signal from AP 121;
1302: transmitting a sounding signal from the STA 111, 112, 113 to the AP 121 in response to the triggering signal; and
1303: receiving, by the STA 111, 112, 113 from the AP 121, precoder information corresponding to a precoder determined by the AP 121 based on the sounding signal and to be used by the STA 111, 112, 113 for data transmission;
1304: wherein the triggering signal comprises an NDPA signal or an NDPR signal and the sounding signal comprises a triggered sounding NDP signal; wherein the triggered sounding NDP signal is based on an EHT TB PPDU frame including a data portion; and wherein the EHT TB PPDU frame transmits a number K of spatial streams SS 1250 in an EHT LTF portion and a number N of SS 1260 in the data portion, the EHT TB PPDU frame being configured to allow K being independent from N.

This corresponds to the method according to the third aspect, however, performed by the STA 111, 112, 113.

As shown in FIGS. 3A and 3B and described above, PPDU type and variant are indicated by PPDU Type and Compressed Mode field 311 in U-SIG 310. In the present disclosure, several options for indication of the new variant are proposed. DL/UL 312b is set to 1 and for all aspects, the same indication may be used for the relevant PPDU type. These options include (i) New value of PPDU Type and Compression Mode Field—for example set PPDU Type and Compression Mode field to ‘2’ (or ‘3’); (ii) U-SIG Validate bit—set PPDU Type and Compression Mode field to ‘0’ and set B2 of U-SIG-2 to ‘1’—may be set to ‘1’ in NDPR also; and (iii) Special Disregard Bits combination—set PPDU Type and Compression Mode field to ‘0’ and use a special combination of 11 disregards bits of U-SIG for Triggered NDP—may be set by NDPR or TF and copied to TB U-SIG.

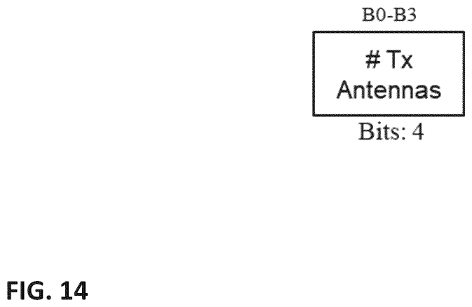

To support accurate UL BF the AP 121 needs to know the number of Tx antennas that STA 111, 112, 113 is equipped with. Thus, with reference to FIG. 14, it is proposed to add a new PHY element 1400 to the capabilities report.

If antenna selection option is used, the AP 121 needs to indicate the subset of Tx antennas for current sounding transmission. This might be done by two following options. The first option refers to indicate first antennas index and 4 bits to indicate number of antennas (8 bits total). According to the second option, all the Tx antennas may be divided to groups of 2, 4 or 8 antennas and AP 121 indicates current group index. 2 bits are needed to indicate group size and 4 bits to indicate group index. For example, if divided to groups of 2 and when AP 121 wants STA 111, 112, 113 to use antennas 5, 6 (3rd group), ‘00’ may be indicated for size of 2 and ‘0011’ may be indicated for 3rd group.

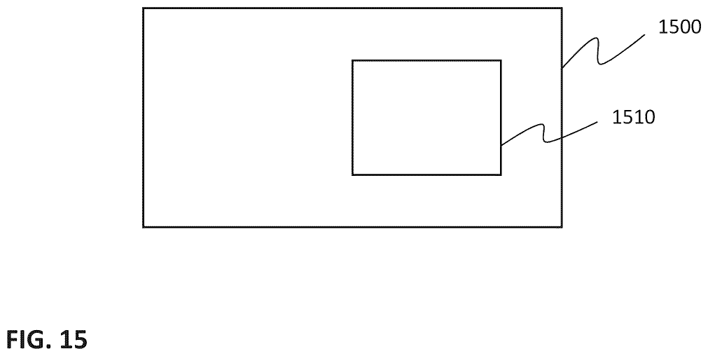

FIG. 15 illustrates an AP 1500 according to the fifth aspect. The AP 1500 comprises processing circuitry 1501 configured to perform the method of uplink sounding signal triggering according to the first or third aspect.

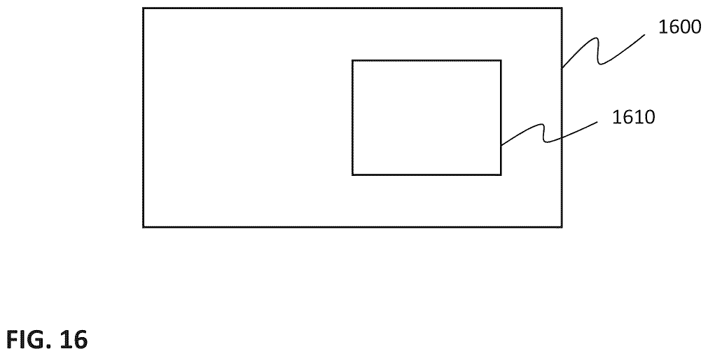

FIG. 16 illustrates an STA 1600 according to the sixth aspect. The STA 1600 comprises processing circuitry 1601 configured to perform the method of uplink sounding signal triggering according to the second or fourth aspect.

The ability to identify the STAs 111, 112, 113, 1600 using power of estimated channel has been simulated. The main idea is that if STA 111, 112, 113, 1600 transmitted a signal, the power of the estimated channel will be high. Otherwise it will be low. Thus, by setting the adjusted threshold it can be recognized which STA 111, 112, 113, 1600 transmitted the signal and which not.

The idea is to compare the power of the estimated channel averaged over all the tones with the average received signal strength indicator (RSSI) of the received signal (triggered signals should pass the threshold).

Two different scenarios at 20 megahertz (MHz) have been simulated.
Case 1: 2 STAs with 6 decibels (dB) difference
Case 2: 2 STAs and interference signal at the same RSSI and 1 STA at 6 dB lower RSSI

Both cases simulated with carrier frequency offset (CFO) uniformly distributed in range of +/−350 Hz, Task Group n (TGn)-D channel and practical Channel Estimation and Synchronization Techniques (CHEST).

It can be seen in FIG. 17 that in both cases very good detection ratio for the weaker STAs (100% at SNR-1 dB) and no false alarms for interference has been achieved.

Summarized, several benefits/motivations of the present disclosure are as follows.

Sounding NDP problem is solved by several methods with minimum changes to the existing PPDU types

Proposed solutions efficiently solve the problems related to UL BF procedure and allows to cover all the possible scenarios

In the several embodiments provided in the present application, it should be understood that a disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments disclosed herein may be integrated into one processing unit, or each of the units may exist alone physically, or two or more units are integrated into one unit.

### Abbreviations

DL: Downlink
UL: Uplink
BF: Beamforming
AP: Access Point
PHY: Physical Layer
MAC: Medium Access Control
PPDU: PHY Protocol Data Unit
STA: Station (in general, can be either an AP STA or a non-AP STA)
NDP: Null Data Packet—a packet which contains preamble, including Long Training Fields (LTFs), and is used for estimating the physical channel between beamformer and beamformee so that the precoder can be computed.
NDPA: NDP Announcement—a frame which is transmitted before an NDP, indicating the format of the NDP (e.g. how many LTFs), which STAs need to respond, what parameters should these STAs use, etc.
BFR: Beamforming Report—a frame which carries the beamforming/precoding information, such as precoding vector or matrix, SNR corresponding to each precoder, etc.
BA: Block-ACK—in 802.11, typically a receiver is expected to respond to a data transmission by responding with an ACK; if multiple frames are transmitted within a single PPDU, each has to be acknowledged
TF: Trigger Frame—in 802.11ax, the Trigger Frame was introduced as a means to trigger an STA or multiple STAs to transmit simultaneously and in sync to the triggering AP

The above described embodiments are exemplary, and the full disclosure is defined by the claims.

1. An access point (AP), comprising:
a transceiver configured to:
transmit, to one or more stations (STAs), a triggering signal comprising a null data packet announcement (NDPA) signal or a null data packet request (NDPR) signal;
receive, in response to the triggering signal, a sounding signal from at least one STA of the one or more STAs, wherein the sounding signal comprises a triggered sounding null data packet (NDP) signal, wherein the triggered sounding NDP signal is based on a trigger-based (TB) physical protocol data unit (PPDU) frame without a payload or an Extremely High Throughput (EHT) multi-user (MU) PPDU frame without a payload, and wherein a universal signal (U-SIG) section of the TB PPDU or the EHT MU PPDU frame comprises parameters indicating a triggered NDP transmission;
receive a precoder for the at least one STA based on the sounding signal; and
transmit precoder information of the precoder to the at least one STA for data transmission.

2. The AP of claim 1, wherein the U-SIG section comprises a PPDU Type and Compressed Mode field indicating a PPDU type and/or a PPDU variant for the triggered sounding NDP signal, and wherein the PPDU type comprises the TB PPDU or the EHT MU PPDU.

3. The AP of claim 2, wherein the PPDU Type and Compressed Mode field is set to 2 or 3.

4. The AP of claim 2, wherein the PPDU Type and Compressed Mode field is set to 0, and wherein a bit (B2) of a U-Sig-2 field in the U-SIG section is set to 1 to indicate the triggered sounding NDP signal.

5. The AP of claim 2, wherein the PPDU Type and Compressed Mode field is set to 0, and wherein the U-SIG section comprises a combination of 11 disregard bits indicating the triggered sounding NDP signal.

6. The AP of claim 1, wherein the U-SIG section comprises an uplink/downlink (UL/DL) field that is set to 1.

7. The AP of claim 1, wherein the U-SIG section comprises a spatial reuse field that is Reserved or set to Disallow such that a spatial reuse is not allowed when the triggered NDP transmission is indicated.

8. The AP of claim 1, wherein a first bandwidth (BW) in the U-SIG section is the same as a second BW of the NDPA signal or the NDPR signal.

9. The AP of claim 1, wherein the U-SIG section comprises a Puncturing Channel Information field that is reserved.

10. A station (STA), comprising:
a transceiver configured to:
receive, from an access point (AP), a triggering signal comprising a null data packet announcement (NDPA) signal or a null data packet request (NDPR) signal;
transmit, to the AP and in response to the triggering signal, a sounding signal comprising a triggered sounding null data packet (NDP) signal, wherein the triggered sounding NDP signal is based on a trigger-based (TB) physical protocol data unit (PPDU) frame without a payload or an Extremely High Throughput (EHT) multi-user (MU) PPDU frame without a payload, and wherein a universal signal (U-SIG) section of the TB PPDU or the EHT MU PPDU frame comprises parameters indicating a triggered NDP transmission;
receive, from the AP, precoder information corresponding to a precoder based on the sounding signal; and
use the precoder information for data transmission.

11. The STA of claim 10, wherein the U-SIG section comprises a PPDU Type and Compressed Mode field indicating a PPDU type and/or a PPDU variant for the triggered sounding NDP signal, and wherein the PPDU type comprises the TB PPDU or the EHT MU PPDU.

12. The STA of claim 11, wherein the PPDU Type and Compressed Mode field is set to 2 or 3.

13. The STA of claim 11, wherein the PPDU Type and Compressed Mode field is set to 0, and wherein a bit (B2) of a U-Sig-2 field in the U-SIG section is set to 1 to indicate the triggered sounding NDP signed.

14. The STA of claim 11, wherein the PPDU Type and Compressed Mode field is set to 0, and wherein the U-SIG section comprises a combination of 11 disregard bits indicting the triggered sounding NDP signal.

15. The STA of claim 10, wherein the U-SIG section comprises an uplink/downlink (UL/DL) field that is set to 1.

16. The STA of claim 10, wherein the U-SIG section comprises a spatial reuse field that is Reserved or set to Disallow such that a spatial reuse is not allowed when the triggered NDP transmission is indicated.

17. The STA of claim 10, wherein a first bandwidth (BW) in the U-SIG section is the same as a second BW of the NDPA signal or the NDPR signal.

18. The STA of claim 10, wherein a Puncturing Channel Information field of the U-SIG section is reserved.

19. A method implemented by an access point (AP), comprising:
transmitting a triggering signal to one or more stations (STAs), wherein the triggering signal comprises a null data packet announcement (NDPA) signal or a null data packet request (NDPR) signal;
receiving, in response to the triggering signal, a sounding signal from at least one STA of the one or more STAs, wherein the sounding signal comprises a triggered sounding null data packet (NDP) signal, wherein the triggered sounding NDP signal is based on a trigger-based (TB) physical protocol data unit (PPDU) frame without a payload or an Extremely High Throughput (EHT) multi-user (MU) PPDU frame without a payload, and wherein a universal signal (U-SIG) section of the TB PPDU or the EHT MU PPDU frame comprises parameters indicating a triggered NDP transmission;
receiving a precoder for the at least one STA based on the sounding signal; and
transmitting precoder information of the precoder to the at least one STA for data transmission.

20. The method of claim 19, wherein the U-SIG section comprises a PPDU Type and Compressed Mode field indicating a PPDU type and/or a PPDU variant for the triggered sounding NDP signal, and wherein the PPDU type comprises the TB PPDU or the EHT MU PPDU.
